(19) United States
(12) Patent Application Publication
(10) Pub. No.: US 2019/0077446 A1
(43) Pub. Date: Mar. 14, 2019

(54) Power-Assisted Steering System Of A Motor Vehicle With An Axial Magnetic Flux Electromagnetic Motor And Parallel Redundant Electrical Power Supply To The Stators Of The Motor

(71) Applicant: WHYLOT SAS, Cambes (FR)

(72) Inventors: Serghei SAVIN, CAPDENAC GARE (FR); Huguette TIEGNA, FIGEAC (FR); Vasile MIHAILA, FIGEAC (FR); Romain RAVAUD, CORN (FR)

(73) Assignee: WHYLOT SAS, CAMBES (FR)

(21) Appl. No.: 15/767,253

(22) PCT Filed: Oct. 12, 2016
(86) PCT No.: PCT/FR2016/000161

§ 371 Date: Apr. 10, 2018

(30) Foreign Application Priority Data
Oct. 12, 2015 (FR) FR1502151
Nov. 5, 2015 (FR) FR1502336

(51) Int. Cl. B62D 5/04; H02K 16/04; H02K 16/02; H02K 1/27

(52) U.S. Cl. CPC B62D 5/0463; H02K 16/04; H02K 16/02; H02K 2213/06; B62D 5/0487; B62D 5/0484; H02K 1/2793

(57) ABSTRACT

The invention relates to a power steering system for a motor vehicle, comprising an electric motor delivering assist torque for a steering wheel of the vehicle. The power steering system also comprises a controller (12) allowing guidance of the motor and the electrical power supply thereof in order to ensure the redundancy of the system. The motor has an axial magnetic flux with at least one air gap between at least two stators (1, 1a to 1d) and at least one rotor, the electrical power of said at least two stators (1, 1a to 1d) being supplied independently in parallel.

The present invention relates to a power steering system of a motor vehicle with an axial magnetic flux electromagnetic motor and parallel redundant electrical power supply to the stators of the motor.

In power steering, an electric motor is used in addition to the manual steering force exerted by the vehicle operator.

In the context of the invention, the axial magnetic flux motor of the power steering system can comprise a rotor with two stators defining therebetween two air gaps or several stators with several rotors defining therebetween more than two air gaps. The electromagnetic motor comprises an output shaft connected to the rotor(s) to deliver the additional torque of the steering force.

For example, document FR-A-2926688 describes a synchronous motor with radial magnetic flux permanent magnets for an electric power steering system for a motor vehicle. It is desired in this document to reduce the thickness of the magnet while maintaining the torque characteristics and demagnetization resistance thereof.

Conventionally, a power steering electromagnetic motor of a motor vehicle motor is intended to deliver assist torque for a vehicle steering wheel. This electromagnetic motor comprises at least one stator and at least one rotor, at least one air gap being defined between said at least one stator and at least one rotor.

At least one permanent magnet is carried by said at least one rotor, while a series of coil members is carried by said at least one stator, said at least one rotor being connected to a motor output shaft transmitting assist torque to the steering wheel.

In power steering applications, the major constraints are reducing the mass and motor footprint for optimal performance.

Document FR-A-2 832 685 discloses a power steering system with three electric motors that operate in parallel being supplied electrically in parallel, the torques delivered by the motors being cumulative during normal operation. This document provides means for detecting a malfunction in all three motors in order to maintain operation in degraded mode. All three motors have a footprint that does not favour placement in a motor vehicle power steering system.

WO-A-99/57000 discloses an electric motor delivering assist torque for a steering wheel of the vehicle, the motor having at least one stator and at least one rotor, at least one air gap being defined between said at least one stator and at least one rotor, at least one permanent magnet being carried by said at least one rotor and a series of coil members being carried by said at least one stator, said at least one rotor being connected to an output shaft of the motor transmitting the assist torque, the motor being an electromagnetic motor axial magnetic flux more than one air gap between at least two stators and at least one rotor. This document does not, however, give any indication as to the ability to adjust the torque simply and efficiently.

The problem underlying the present invention is to design a power steering system with a single electromagnetic motor that can deliver high mass torque having a smallest possible space, the torque delivered by this power steering system being adjustable according to the driving conditions with the possibility of redundancy.

For this purpose, according to the invention, a motor vehicle power steering system is provided comprising an electric motor delivering assist torque for a steering wheel of the vehicle, the motor having at least one stator and at least one rotor, at least one air gap being defined between said at least one stator and at least one rotor, at least one permanent magnet being carried by said at least one rotor, whereas a series of coil members is carried by said at least one stator, said at least one rotor being connected to a output shaft of the motor transmitting the assist torque, the power steering system also comprising a controller for guiding the motor and power supply therefor, characterized in that the motor is an axial magnetic flux electromagnetic motor and an air gap or multiple air gaps between at least two stators and at least one rotor, the power supply of said at least two stators is parallel and independent.

In the specific non-limiting case of a single air gap, the present invention is able to meet the constraints of power and size in that it provides high mass torque to a small diameter and a smaller axial length than a power steering system equipped with an electromagnetic motor with radial flux to a single air gap of the same diameter.

There was a strong prejudice against the use of an electromagnetic motor with an axial magnetic flux, which has been overcome by the present invention.

In the specific and non-limiting case of a failure redundancy of at least one of the stators requiring, according to the state of the art, several motors, the present invention uses only an axial flux motor with several air gaps, the motor also being referred to as a multiple air gaps axial flux motor and thus a smaller footprint that several motors with their respective structures taking up space.

Generally, the present invention makes it possible to modulate the power and distribution of workload onto different sets of stators and rotors forming part of a same motor. While in the prior art, except in the event of redundancy, only one motor is used with a single stator and rotor, the present invention allows at least one motor but with multiple stators and multiple rotors, the electrical current is shared by the stators which are powered in parallel. So there are more numerous opportunities for modulation of the torque supplied by the motor than those offered by the state of the art.

Advantageously, at least two motors with axial magnetic flux with one or more air gaps are connected in parallel, the power steering system comprising mechanical coupling and decoupling means of the shafts of said at least two motors. This capability solves a problem occurring in a rotor in a motor, for example a magnet detachment.

In this case, as it is not possible to isolate a magnet rotor that is down in such a motor since all the rotors of the motor have the same shaft, there is the risk that the debris from a detached magnet might create a short circuit on the stators of the motor thus putting the entire motor off-line. To avoid this, it is necessary to stop the axial flux motor and replace its operation with a second axial flux motor that was redundant.

It should be borne in mind that a power steering system comprising at least one axial flux motor was not known in the state of the art, a radial flux motor is preferred thereto. An axial flux motor has a smaller footprint than a radial flux motor. Even if there were a combination of two radial flux motors connected in parallel, this assembly would be significantly bulkier than two axial flux motors as proposed by the present invention. It is therefore more advantageous in terms of weight, mass and size to combine several axial flux motors in parallel for ensure redundancy than several radial flux motors.

Advantageously, the electromagnetic motor comprises at least one rotor interposed between at least two stators and at least one stator interposed between at least two rotors connected to the output shaft of the motor, with an air gap between each rotor and each stator interposed respectively between stators and rotors which are on either side of same.

Advantageously, when the electromagnetic motor comprises a plurality of rotors, the rotors are successively connected to the output shaft of the motor or are connected to a respective shaft connected to the output shaft of the motor.

Advantageously, when the electromagnetic motor comprises at least two stators, said at least two stators are electrically connected or in parallel.

Advantageously, at least two motors with axial magnetic flux and multiple air gaps are connected in parallel, the power steering system comprising a mechanical coupling and decoupling means for the shafts of said at least two motors.

Advantageously, the controller comprises means for varying the intensities of the current respectively supplying one of said at least two stators between zero current and a maximum current, a motor control being made up of at least two different command control means. It is then, for example, possible to use sparingly a series of coils of a stator relative to other series of coils of other stators by applying an electrical current less than that of the other stators. The stator(s) ensuring redundancy may for example be supplied with a low electrical current or be non-powered. The electrical currents of the stators of the axial flux motor may also differ according to the additional torque required.

Advantageously, the controller comprises means for calculating or detection of the additional torque required by the steering system to the steering wheel of the vehicle and means of calculating the current of the power supply of at least a portion of said at two stators to deliver the rated torque. This can help to respond appropriately to torque required for steering the vehicle.

Advantageously, said at least two stators are electrically powered simultaneously. This is the case other than for pure redundancy for which a stator is not powered electrically.

Advantageously, at least one of said at least two stators is not powered electrically for redundancy and the controller comprises activation control means of the power supply of said at least one stator providing redundancy when the means of detecting an anomaly present at least on the other or at least one of the other electrically powered stators detect(s) a malfunction of the stator associated thereto, the detection means being connected to means for signalling an anomaly belonging to the controller. Thus, the controller can detect a malfunction, or even an indication of a future malfunction of a stator and switch same off replacing it with the redundant stator(s) to provide or facilitate the torque.

Advantageously, the anomaly detecting means detects a short circuit in a series of coil members carried by the other or at least one of the other stator(s). A short circuit is a failure that may occur in a series of coils of a stator and detection thereof, particularly when it is premature, proves highly advantageous for the operation of the power steering system.

Advantageously, when the controller includes the means for rating the torque to be provided by the power steering system, and means for calculation of the current intensities at at least a portion of said at least two stators for providing the rated torque, means for measuring the actual output torque of the motor and means for comparing the rated torque with the effective torque, the controller comprising means for controlling activation of power to said at least one stator providing redundancy, when the comparison means indicate a lower effective torque to the rated torque. Electrical currents supplying the stator may therefore be adapted according to the torque, whether by increased or decreased current.

Advantageously, the electromagnetic motor is associated with a speed-increasing gear.

Advantageously, each of the coil members comprises a tooth on a coil, each tooth being flanked on each side by a notch, the notches of all the series of coil members having means for channelling the magnetic flux.

Advantageously, the notches are closed over most of their faces vis-à-vis the associated air gap, an aperture for blocking the passage of magnetic flux being present on said face and the teeth not including iron, being made of plastic, composite, ceramic or glass and each of the coil members comprises a separating element arranged between each notch of a tooth and the notch of the next tooth.

The invention also relates to a method for controlling an electromagnetic motor with an axial magnetic flux with one or more air gaps of such a power steering system, wherein the stators are powered electrically for delivering an assist torque for a steering wheel of the vehicle, characterized in that, when an anomaly is detected in an electrically powered stator, power to said at least one stator is deactivated.

The invention also relates to a method for controlling an electromagnetic motor with an axial magnetic flux in one or more air gaps of such a power steering system, characterized in that the current of the power supply of each stator is adjustable as a function of the torque to be supplied by the power steering system, electric current is equally distributed among all the stators or at least one of the stators being not electrically powered or powered at a lesser current than other stators.

Other features, objectives and advantages of the present invention will emerge on reading the detailed description that follows and the accompanying drawings given as non-limiting examples and in which:

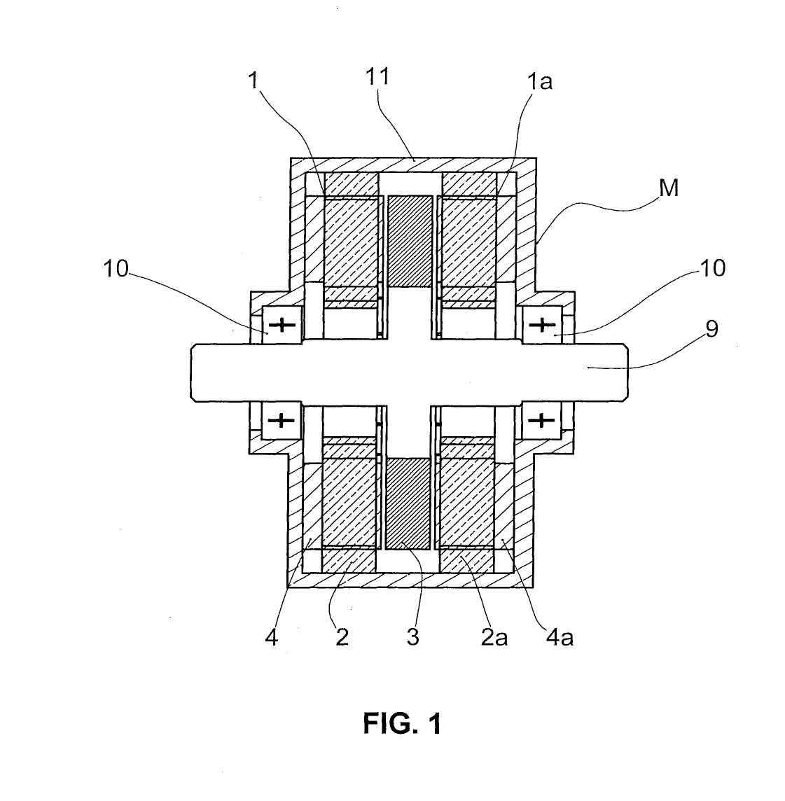

FIG. 1 is a schematic representation of an axial sectional view of one embodiment of a multiple air gap motor with integrated axial flux in a power steering system according to the present invention, the electromagnetic motor according to this embodiment comprising two stators and a rotor,

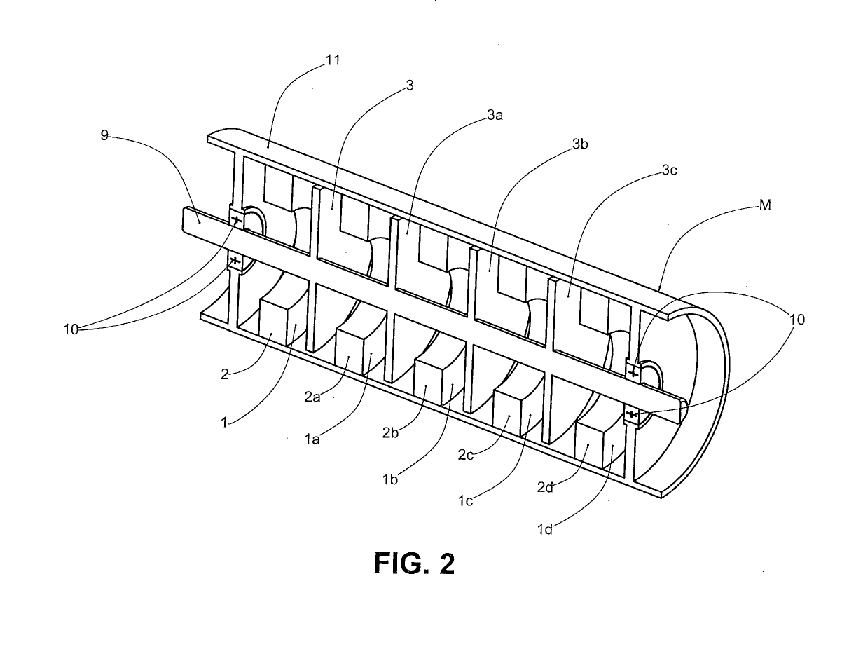

FIG. 2 is a schematic representation of a perspective view in axial half-section of another embodiment of a multiple air gap motor with integrated axial flux in a power steering system according to the present invention, the electromagnetic motor according to this embodiment comprising a plurality of stators and a plurality of rotors,

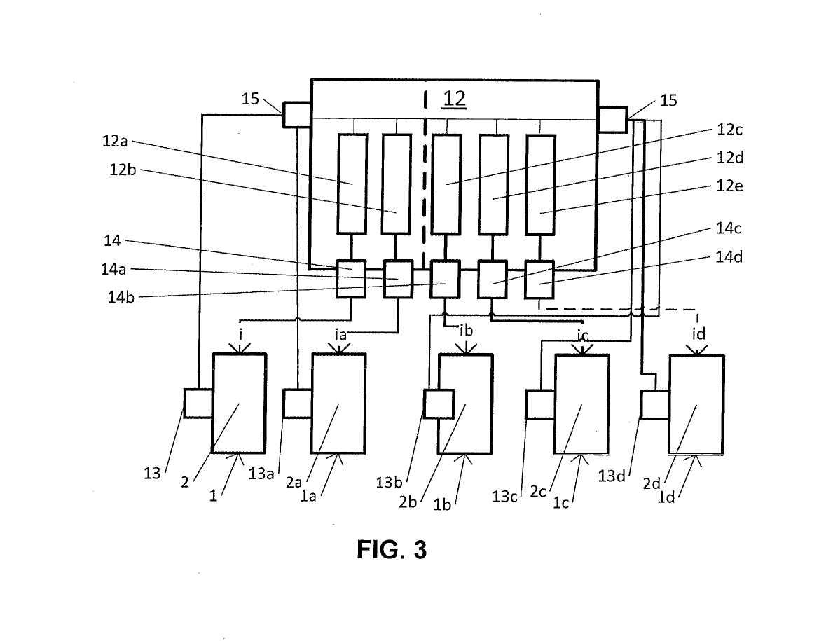

FIG. 3 is a schematic representation of a controller for a power steering control according to the present invention, this controller being associated with detection sensors and the stators of the electromagnetic motor with axial flux.

FIG. 1 shows a longitudinal view of the electromagnetic motor M having a double air gap with a rotor 3 with or without iron carrying one or more magnets. The rotor 3 is placed between two stators 1, 1a having a magnetic circuit 4, 4a and comprising a series of coil members 2, 2a. The assembly formed by the rotor 3 and the stators 1, 1a is arranged around an output shaft 9 of the motor M rigidly connected to the rotor 3. Bearings 10 allow rotational movement of the rotor 3 and the output shaft 9 about a longitudinal axis of the motor M along which the shaft 9 extends. A structure 11 makes it possible to maintain, protect and assemble parts of the engine M.

FIG. 2 shows a longitudinal half-section parallel to the longitudinal axis of the motor M in perspective view. The motor M comprises four rotors 3, 3a, 3b, 3c carrying the magnets. The four rotors 3, 3a, 3b, 3c are inserted between five stators 1, 1a, 1b, 1c, 1d each having each at least one series of coil members 2, 2a, 2b, 2c, 2d. Respective air gaps are provided between each rotor 3, 3a, 3b, 3c and two stators 1, 1a, 1b, 1c, 1d which are on either side of same.

Each of the rotors 3, 3a to 3c and each of the stators 1, 1a to 1d are advantageously in the form of a disk centred about the output shaft 9 of the motor M. All these discs are concentric and arranged axially one after the other with respect to the motor's longitudinal axis along which the output shaft 9 of the motor M extends.

The rotors 3, 3a to 3c are connected to the output shaft 9. The stators 1, 1a to 1d are also the form of discs can be connected together at the outer periphery thereof by a cylindrical shape forming a structure 11 covering same.

The structure 11 also remotely covering the rotors 3, 3a to 3c is connected to the output shaft 9 by bearings 10, advantageously at each of the ends thereof. The output shaft 9 and the rotors 3, 3a to 3c can therefore rotate freely about the structure 11.

Generally, as the embodiments shown in FIGS. 1 and 2 are not limiting, while referring to these figures with the reference numerals, the present invention relates to an electromagnetic motor M comprising at least one stator 1, 1a to 1d and at least one rotor 3, 3a to 3c, at least one air gap being defined between said at least one stator 1, 1a to 1d and at least one rotor.

In this motor M, at least one permanent magnet is carried by said at least one rotor 3, 3a to 3c, while a series of coil members 2, 2a to 2d is carried by said at least one stator. The rotor or rotors 3, 3a to 3c present in the motor M are connected to an output shaft 9 of the motor M transmitting the assist torque. One such motor M is integrated in a motor vehicle power steering system delivering an assist torque for a vehicle steering wheel. The power steering system also comprises a controller 12 for the motor M and the power supply thereof.

According to the present invention, the motor M is an electromagnetic motor M with axial magnetic flux having one or more air gaps between at least two stators 1, 1a to 1d and at least one rotor 3, 3a to 3c, the power to said at least two stators 1, 1a to 1d being supplied in parallel. This completely differs from the power steering of the prior art, the motors M widely used in these known power steering systems being motors M with radial flux. Such an electromagnetic axial flux motor M according to the present invention can be associated or not with a speed-increasing gear.

In FIG. 1, two air gaps are shown between a rotor 3 and two stators 1, 1a while in FIG. 2 eight air gaps are shown between five stators 1, 1a to 1d and four rotors 3, 3a to 3c. In other embodiments of the invention, the electromagnetic motor M may comprise at least one rotor 3, 3a to 3c interposed between at least two stators 1, 1a to 1d, which corresponds to the embodiment illustrated in FIG. 1.

In other embodiments of the invention, one of these embodiments being for example shown in FIG. 2, the electromagnetic motor M may be made up of at least two stators 1, 1a to 1d and at least two rotors 3, 3a to 3c connected to the output shaft 9 of the motor M, in FIG. 2 five stators 1, 1a to 1d and four rotors 3, 3a to 3c. Generally, the motor M may comprise n stators 1, 1a to id and n+1 rotors 3, 3a to 3c or n−1 rotors 3, 3a to 3c. There may also be at least one stator 1, 1a to 1d interposed between at least two rotors 3, 3a to 3c.

In the latter case, said at least two rotors 3, 3a to 3c are connected to the output shaft 9 of the motor M. In all these methods, an air gap between each rotor 3, 3a to 3c or each stator 1, 1a to 1d is interposed between the stators 1, 1a to 1d or rotors 3, 3a to 3c, which are on either side of same.

When the electromagnetic motor M comprises a plurality of rotors 3, 3a to 3c, the rotors 3, 3a to 3c can be connected successively to the output shaft 9 of the motor M or are connected to a respective shaft connected to the output shaft 9 of the motor M. This is the first arrangement of successive rotors 3, 3a to 3c which is the preferred arrangement.

In general, it is preferred that either the rotor(s) 3, 3a to 3c which carry magnets and or the stator(s) 1, 1a to 1d which carry the coil members 2, 2a to 2d but this may be reversed.

Preferably, the rotor(s) 3, 3a to 3c are made of a single piece ring magnet. This magnet may be selected from, but not limited to, ferrite magnets, to the rare earth-based magnets such as neodymium-iron-boron magnets or samarium cobalt magnets, magnets made from aluminium, nickel and cobalt, with or without thermoplastic binder.

When the electromagnetic motor M comprises at least two stators 1, 1a to 1d, the two stators 1, 1a to 1d or more are electrically connected independently in parallel.

In one embodiment of the invention, there may be at least two motors M with axial magnetic flux and multiple air gaps which are connected in parallel. The power steering system therefore comprises a mechanical means for coupling and decoupling the shafts of said at least two motors M. These two motors can work simultaneously or alternately. A preferred embodiment provides for redundancy on a motor M having a problem with at least one rotor, which frequently requires completely stopping the motor M, the rotors 3, 3a, 3b, 3c of a motor M being mounted on the same shaft.

As is visible in FIG. 3, while referring in particular to FIG. 2, the controller 12 may comprise means 14, 14a to 14d of varying the intensities, i, ia to id of the current supplied respectively to one of said at least two stators 1, 1a to 1d between zero current and a maximum current, the motor being controlled by at least two different variation means 14, 14a to 14d. The controller 12 may also comprise control means 12a to 12d.

The controller 12 may also comprise means for calculating or detecting the assist torque applied to the steering wheel of the vehicle and means for calculating the intensities i, ia to id of the power supply of at least a portion of said at least two stators 1, 1a to 1d for delivering the rated torque.

It is possible to have several embodiments of the invention. For example, all the stators 1, 1a to 1d can be electrically supplied simultaneously in parallel.

In another embodiment, still referring primarily to FIGS. 2 and 3, at least a one of said at least two stators 1, 1a to 1d is not electrically powered to provide redundancy. The power supply line with an intensity of id of this stator ensuring redundancy 1d is drawn in dotted lines in FIG. 3 to show that this stator 1d may not be electrically powered. There may be several stators ensuring redundancy although only one is shown in FIG. 3.

In this embodiment, the controller 12 comprises means for controlling activation of the power supply of the stator providing redundancy 1d when means 3, 13a to 13c for detecting an anomaly present on at least the other or at least one of the other electrically powered stators 1, 1a to 1c detect a malfunction of the stator 1, 1a to 1c associated thereto.

It is also possible to provide the stator(s) ensuring redundancy 1d with detection means 13d so as not to reduce the role of said stator(s) to providing redundancy 1d.

To do this, the detection means 13, 13a to 13d can be connected to the means 15 for signalling an anomaly which is part of the controller 12. In FIG. 3, separate signalling means 15 are shown but these means can be grouped together.

It is thus possible to use only part of the stators 1, 1a to 1c to provide redundancy with one or more reserve stators 1d. The reserve stator(s) ensuring redundancy 1d are connected in the event of failure of the other or one of the active stators 1, 1c.

The detected anomaly can be of several types. For example, an excessive increase in temperature of the series of coil members 2, 2a to 2d in operation may be representative of a malfunction. The most serious anomaly is, however, a short circuit in at least one series of coil members 2, 2a to 2d. The means 13, 13a to 13c for detecting an abnormality can thereby detect a short circuit in a series of coil members 2, 2a to 2c carried by the other or at least one of the other stators 1, 1a to 1c.

Typically, a series of coil members 2, 2a to 2d is composed of a series of coils made of metallic wire that is a good conductor of electricity, for example aluminium or copper, a tooth and two notches around each tooth on each of its sides. This thread can cause a short circuit when it is poorly insulated. This wire may also break and thus no longer allow power to be supplied to the stator associated thereto. The means 13, 13a to 13c for detecting an anomaly can also control the electric current i, ia to is in the stators 1, 1a-c.

The stator(s) providing redundancy 1d can also be supplied electrically when the operation of the power steering system requires it even if there is not necessarily a serious anomaly for the other stator(s) 1, 1a to 1c.

Thus, the controller 12 may comprise means for rating the torque to be provided by the power steering system and means for calculating currents i, ia to id at at least a portion of said at least two stators 1, 1a to 1c for delivering the rated torque, means for measuring the effective output torque of the motor M and means for comparing the rated torque and the effective torque.

In this case, when the comparing means indicates effective torque lower than the rated torque, the controller 12 may comprise control means for activating the power supply to the stator(s) or providing redundancy 1d.

The stator having an anomaly or representative behaviour of excessive aging can be turned off by the controller 12 to protect same. The controller 12 may then comprise means for controlling an interruption of power to the stator having an anomaly when the means for activating the power supply of said stator providing redundancy 1d are in operation.

The series of coil members 2, 2a to 2d of one of the two stators 1, 1a to 1d or more can be angularly offset with respect to the series of coil members 2, 2a to 2d of the other stator.

Each of the coil parts 2, 2a to 2d may comprise a tooth carrying a coil, each tooth being flanked on each side thereof by a notch. The teeth present on an external stator 1, 1a to 1d can be offset with respect to teeth present on another stator.

Similarly, the notches of all coil series may have means for channelling the magnetic flux. The notches are advantageously closed over most of their faces vis-à-vis the air gap associated thereto, a magnetic flux passage opening being present on said face.

The teeth may be made of iron, as is conventional, or not include iron, which can reduce a cogging torque being applied to the motor M. In this case, the teeth can be plastic, composite, ceramic or glass.

In a preferred embodiment of the present invention, a separating element is arranged between each notch of a tooth and the notch of the next tooth. The term separating element characterizes a member located between the two notches.

This separating member can be made of ferromagnetic material when the coil teeth are made of iron or ferromagnetic material. Alternatively, the separating member may be made of insulating material when the teeth do not contain iron. Advantageously, the teeth and the separating members for each internal or external stator 1, 1a to 1d are part of the same member.

What was described as an anomaly in one or more stators 1, 1a to 1c, also applies to an anomaly regarding a rotor 3, 3a to 3c.

The power steering system according to the present invention may comprise at least two rotors 3, 3a to 3c, wherein one 3c of said at least two rotors 3, 3a to 3c is associated with a stator 1d specifically dedicated thereto, said stator being unpowered electrically and providing redundancy 1d.

The most common anomaly affecting a rotor is the loss of a magnet or magnets by detachment of the rotor. According to the present invention, it is preferred to stop the motor M having at least one defective rotor. For this reason, it is provided to attach another axial flux motor with several air gaps in parallel to an axial flux motor with a plurality of air gaps.

This anomaly can be detected in one or more rotors 3, 3a, 3b, 3c by a presence sensor that detects the at least one permanent magnet carried by same.

The presence sensor(s) can be connected to means for signalling an anomaly that is part of the controller 12. When the one or more presence sensors indicate the absence of said at least one permanent magnet on at least one of the rotors 3, 3a to 3c. When the power steering system comprises a second axial flux motor attached in parallel to the first motor having a deficiency in at least one rotor 3, 3a to 3c, the controller 12 may comprise means for stopping the first motor M and means for activating the power supply of the second motor M.

The anomaly may also relate to damage to the magnet(s) and/or demagnetization of the magnet(s) or other problems relating to magnets.

In one embodiment, the rotor(s) 3, 3a to 3c of the motor M may comprise several magnets. However, it is preferred for the rotor(s) 3, 3a to 3c comprise(s) a single magnet. It is therefore necessary to verify that this sole magnet properly fulfils its role.

The present invention may comprise a method of controlling an axial magnetic flux electromagnetic motor M with one or more air gaps of a power steering system as described above. In this method, the stators 1, 1a to 1c are electrically powered to deliver assist torque to a vehicle steering wheel.

When an anomaly is detected in an electrically powered stator 1, 1a to 1c, the power supply to said at least one stator is deactivated and, where appropriate, the power supply to the stator providing redundancy is deactivated.

In another embodiment of a method for controlling such an axial magnetic flux electromagnetic motor M with one or more air gaps of a power steering system, the power supply current i, is to id of each stator 1, 1a to 1d is adjustable on the basis of the torque to be provided by the power steering.

Therefore, it is advantageous for the electric current i, is to id to be equally distributed among all the stators 1, 1a to 1d. Alternatively, a 1d of at least the stators 1, 1a to 1d may be not electrically powered or powered at a lesser current id than the other stators 1, 1a to 1c, for example, for using this 1d stator sparingly or to having it fulfil the role of redundancy stator.

In an axial flux motor M with several air gaps, it is possible to change stator(s) to guarantee redundancy 1d. This makes it possible to use the stators 1, 1a to 1d in a similar way to make them last as long as possible.

The invention is not limited to the described and illustrated embodiments which have been given only as examples.

1. A motor vehicle power steering system comprising an electric motor delivering assist torque to a steering wheel of the vehicle, the motor comprising at least one stator and at least a rotor, at least one air gap being defined between said at least one stator and at least one rotor, at least one permanent magnet being carried by said at least one rotor and a series of coil members being carried by said at least one stator, said at least one rotor being connected to an output shaft of the motor transmitting the assist torque, the power steering system also comprising a controller for guiding the motor and the power supply thereof, in which the motor is a axial magnetic flux electromagnetic motor with an air gap or multiple air gaps between the least two stators and at least one rotor, the power supply of said at least two stators being in parallel independently.

2. A power steering system according to claim 1, wherein the motor comprises at least one electromagnetic rotor interposed between at least two stators or at least one stator interposed between at least two rotors connected to the output shaft of the motor, with an air gap separating each rotor or each stator respectively interposed between stators or rotors which are on either side of same.

3. A power steering system according to claim 1, wherein, when the electromagnetic motor comprises a plurality of rotors, the rotors are successively connected to the output shaft of the motor or are connected to a respective shaft connected to the output shaft of the motor.

4. A power steering system according to claim 1, wherein at least two motors with axial magnetic flux and with multiple air gaps are connected in parallel, the power steering system comprising a mechanical means of coupling and decoupling of the shafts from said at least two motors.

5. A power steering system according to claim 1, wherein the controller comprises means for varying of the intensities of the current supplied respectively to one of said at least two stators between a zero current and a maximum current, the engine being guided by at least two different control means.

6. A power steering system according to claim 5, wherein the controller comprises means of calculating or detecting the assist torque applied to the steering wheel of the vehicle and means of calculating the current of the electrical supply of at least a portion of said at least two stators for providing the rated torque.

7. A power steering system according to claim 1, wherein each of the coil members of the stator comprise a tooth carrying a coil, each tooth of same being flanked on each side thereof by a notch, the notches of all the series of coil members having means for channelling the magnetic flux.

8. A power steering system according to claim 7, wherein the notches of the stators are closed over most of their surfaces vis-a-vis the associated air gap, an aperture for blocking the magnetic flux passage being present on said surface and the teeth do not comprise iron, being made of plastic, composite, ceramic or glass and each of the coil members comprise a separating member arranged between each notch of a tooth and the notch of the successive tooth.

9. A power steering system according to claim 1, wherein said at least two stators are electrically powered simultaneously.

10. A power steering system according to claim 1, wherein at least one of said at least two stators is not electrically powered for redundancy and the controller comprises means for controlling the activation of the power supply of said at least one stator providing redundancy when the means for detecting an anomaly present in at least the other or at least one of the other electrically powered stators detect a malfunction of the stator associated thereto, the detection means being connected to the means for signalling an anomaly being part of the controller.

11. A power steering system according to claim 10, wherein the means for detecting an anomaly detect a short circuit in a series of coil members carried by the other or at least one of the other stators

12. A power steering system according to claim 10, wherein, when the controller comprises means for rating the torque to be provided by the power steering system and means for calculating the intensities of the current at at least a portion of said at least two stators for delivering the rated torque, means for measuring the effective output torque of the motor and means for comparing the rated torque with the effective torque, the controller comprising means for controlling the activation of the power supply of said at least one stator providing redundancy, when the comparison means indicate an effective torque lower than the rated torque.

13. A power steering system according to claim 1, wherein the electromagnetic motor is associated with a speed-increasing gear.

14. A method of controlling an axial magnetic flux electromagnetic motor with one or more air gaps of a power steering system according to claim 1, wherein the stators are electrically powered for delivering an assist torque for a steering wheel of the vehicle, in which, when an anomaly is detected on an electrically powered stator, the power to said stator is deactivated.

15. A method of controlling an axial magnetic flux electromagnetic motor with one or a plurality of air gaps of a power steering system according to claim 1, characterized in that the current of the power supply of each stator is adjustable according to the torque to be provided by the power steering system, the current being equally distributed among all the stators or at least the stators being not electrically powered or supplied at a current lower than the other stators.
